(19) United States
(12) Patent Application Publication
(10) Pub. No.: US 2013/0080717 A1
(43) Pub. Date: Mar. 28, 2013

(54) INFORMATION PROCESSING APPARATUS AND CONTROL METHOD

(71) Applicant: Keiichi Uehara, Ome-shi (JP)

(72) Inventor: Keiichi Uehara, Ome-shi (JP)

(73) Assignee: KABUSHIKI KAISHA TOSHIBA, Tokyo (JP)

(21) Appl. No.: 13/529,750

(22) Filed: Jun. 21, 2012

(30) Foreign Application Priority Data
Sep. 28, 2011 (JP) 2011-213300

(51) Int. Cl. G06F 12/00

(52) U.S. Cl. 711/154; 711/E12.001

(57) ABSTRACT

According to one embodiment, an apparatus includes a volatile memory, a nonvolatile semiconductor disk drive, a hibernation control module, a resume control module, and a release module. The drive includes SLC and MLC areas. The hibernation control module saves system context data in a first storage area in the SLC area in response to a hibernate request. The system context data includes contents of the volatile memory. The resume control module reads the system context data from the first storage area to restore the contents of the volatile memory, in response to a resume request. The release module releases the first storage area so as to allow the first storage area to be used to store other data, in response to completion of the read of the system context data.

### CROSS-REFERENCE TO RELATED APPLICATIONS

This application is based upon and claims the benefit of priority from Japanese Patent Application No. 2011-213300, filed Sep. 28, 2011, the entire contents of which are incorporated herein by reference.

### FIELD

Embodiments described herein relate generally to an information processing apparatus including a nonvolatile semiconductor disk drive, and a control method applied to that apparatus.

### BACKGROUND

In recent years, various computers such as laptop type personal computers and desktop type personal computers have been developed. Most of such computers have a power management function. The power management function can transit a state of a computer from a working state to a sleep or hibernate state. In the hibernate state, almost all system components are powered off while system context data (hibernate data) including contents of a memory is saved in a nonvolatile storage device such as a hard disk drive.

Also, recent computers use a nonvolatile semiconductor disk drive (for example, a solid-state drive (SSD)) in place of a hard disk drive (HDD). There are two types of SSDs, that is, a single-level cell (SLC) SSD and multi-level cell (MLC) SSD. The SLC SSD has features of a larger number of rewritable times and a higher access speed than the MLC SSD. However, the SLC SSD requires higher cost than the MLC SSD. Therefore, in most cases, a personal computer uses the MLC SSD.

Recently, an SSD having both SLC and MLC areas has begun to develop.

However, the utilization method of the SSD having both the SLC and MLC areas is limited under the present circumstances, and only a method of using the SLC area to store data, which is required to be rewritten frequently (for example, file management information), is used.

In order to enhance the operation speed and reliability of a personal computer without increasing cost of the personal computer, a novel technique for effectively using the SSD having the SLC and MLC areas is needed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an information processing apparatus according to an embodiment;

FIG. 2 is an exemplary view for explaining an overview of the information processing apparatus according to the embodiment;

FIG. 3 is an exemplary block diagram showing the system arrangement of the information processing apparatus according to the embodiment;

FIG. 4 is an exemplary flowchart showing the procedure of transition processing to a hibernate state, which processing is executed by the information processing apparatus according to the embodiment;

FIG. 5 is an exemplary flowchart showing the procedure of transition processing from the hibernate state to a working state, which processing is executed by the information processing apparatus according to the embodiment;

FIG. 6 is an exemplary flowchart showing the procedure of data write processing, which is executed by an SSD included in the information processing apparatus according to the embodiment; and

FIG. 7 is an exemplary diagram showing the configuration of a BIOS of the information processing apparatus according to the embodiment.

### DETAILED DESCRIPTION

Various embodiments will be described hereinafter with reference to the accompanying drawings.

In general, according to one embodiment, an information processing apparatus includes a volatile memory, a nonvolatile semiconductor disk drive, a hibernation control module, a resume control module, and a release module. The nonvolatile semiconductor disk drive includes a single-level cell (SLC) area and a multi-level cell (MLC) area. The hibernation control module is configured to save system context data in a first storage area in the SLC area in response to a hibernate request. The system context data includes contents of the volatile memory. The resume control module is configured to read the system context data from the first storage area to restore the contents of the volatile memory, in response to a resume request. The release module is configured to release the first storage area so as to allow the first storage area to be used to store other data, in response to completion of the read of the system context data.

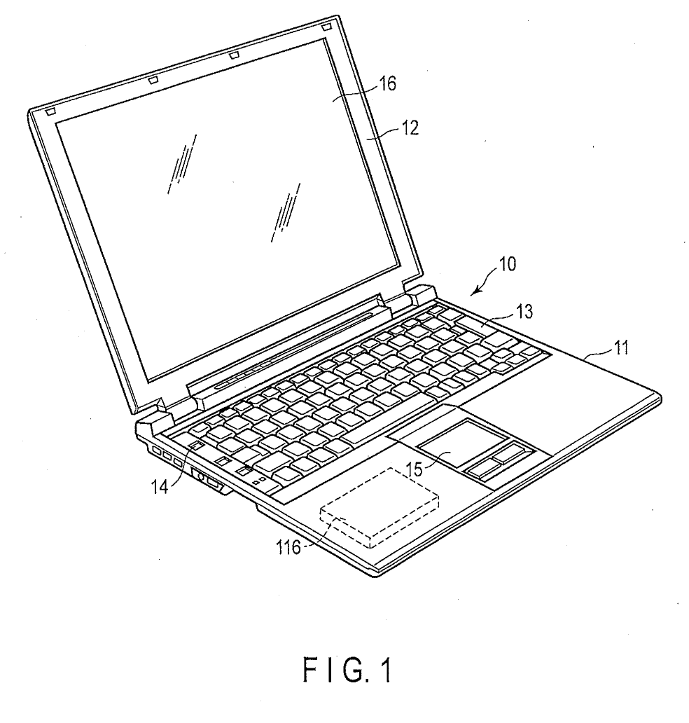

FIG. 1 is a perspective view showing the outer appearance of an information processing apparatus according to this embodiment. This information processing apparatus is implemented as, for example, a notebook type personal computer (PC) 10. Alternatively, this information processing apparatus may be implemented as a server, desktop PC, tablet PC, slate PC, or the like.

As shown in FIG. 1, this computer 10 is configured by a computer main body 11 and display unit 12. A display device configured by an LCD (Liquid Crystal Display) 16 is built in the display unit 12.

The display unit 12 is attached to the computer main body 11 such that the display unit 12 is rotatable between an opening position where the upper surface of the computer main body 11 is exposed, and a closing position where the upper surface of the computer main body 11 is covered. The computer main body 11 has a low-profile box-shaped housing, and a keyboard 13, a power button 14 used to power on/off the computer 10, and a pointing device 15 (for example, a touch pad) are disposed on its upper surface. In an information processing apparatus of another type, a mouse, touch panel, or the like may be equipped as the pointing device 15.

The computer main body 11 includes a solid state drive (SSD) 116. The SSD 116 is a nonvolatile semiconductor disk drive, and includes, for example, NAND flash memories. Types of structures of cells which configure storage areas of the NAND flash memory include a single-level cell (SLC) and multi-level cell (MLC). These two different cells have different features in terms of performance, cost, and the like. As for the performance, the SLC can store data of 1 bit, while the MLC can store data of 2 bits or more. For this reason, in general, cost per area occupied by one cell of the SLC is higher than the MLC. Therefore, the MLC is used more popularly than the SLC. The SLC has a larger number of data rewritable times than the MLC. For this reason, the SLC is a cell having higher reliability than the MLC. Furthermore, the SLC has higher data read and write speeds than the MLC. Note that the NAND flash memory included in the SSD 116 may be a nonvolatile memory other than the NAND flash memory, as long as it has different characteristics such as the SLC and MLC, as described above.

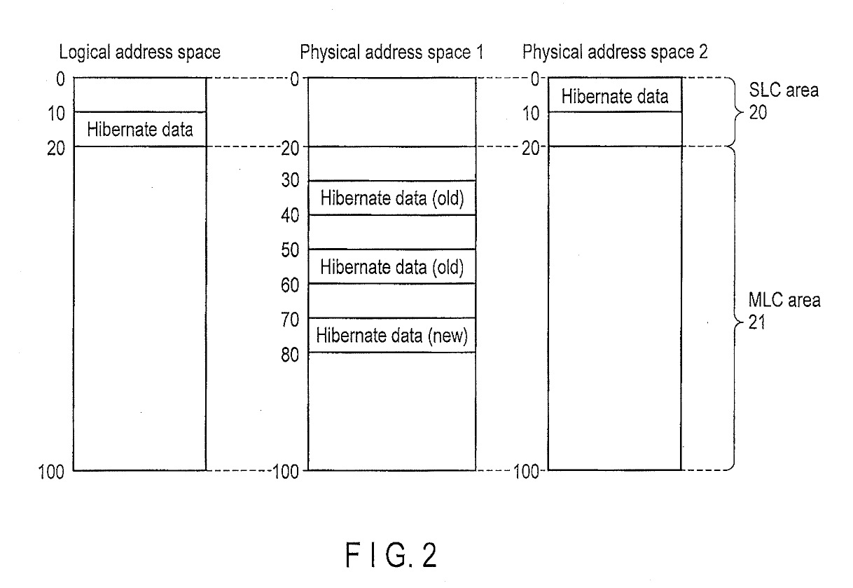

An overview of this embodiment will be described below with reference to FIG. 2.

The computer 10 transits to various states related to a power. The various states (power state) related to the power include, for example, a working state, sleep state (suspend state), and hibernate state. The working state is a state in which the computer 10 is powered ON. That is, the working state is an active state of the computer 10. The working state is a state in which electric power is supplied to components such as a CPU and the LCD 16 included in the computer 10. The sleep state is also a state in which electric power is supplied to a volatile memory (RAM) or the like, which stores system context data, and almost all components other than the RAM are powered off.

On the other hand, the hibernate state is a state in which system context data (hibernate data) including the contents of the volatile memory (RAM) is saved in a nonvolatile storage device such as a hard disk drive, and almost all system components including the RAM are powered off. Therefore, for example, in the hibernate state, electric power need not be supplied to the computer 10 unlike in the sleep state. By reading out the hibernate data upon activating the computer 10, a state of the computer 10 immediately before it transited to the hibernate state can be restored. The hibernate state indicates a state of S4 in the ACPI (Advanced Configuration and Power Interface) specification.

The overview of this embodiment will be described below in detail with reference to FIG. 2.

In this embodiment, the hibernate data is saved in a nonvolatile storage device. The aforementioned SSD 116 is used as the nonvolatile storage device. The SSD 116 includes two areas, that is, an SLC area 20 and MLC area 21. The SLC area 20 is a storage area configured by a large number of cells of an SLC type. The MLC area 21 is a storage area configured by a large number of cells of an MLC type. The SLC area 20 and MLC area 21 are those which have the aforementioned SLC and MLC features. As for data read and write accesses, the SLC area 20 has higher data read and write speeds than the MLC area 21. The storage capacity of the MLC area 21 is larger than that of the SLC area 20.

Hibernate data is assigned to 10th to 20th addresses on a logical address space shown in FIG. 2. The hibernate data assigned on the logical address space is written in the SLC area 20 on a physical address space of the SSD 116. Note that in FIG. 2, the physical address space is indicated by two different names, that is, a physical address space 1 and physical address space 2, but different names are used for the sake of descriptive convenience. For this reason, the physical address spaces 1 and 2 indicate the same physical address space of the SSD 116.

In this embodiment, the hibernate data is written in a storage area (first storage area) secured in the SLC area 20. However, in order to explain the usability of this embodiment, a case will be assumed first wherein the hibernate data is written in the MLC area 21. As described above, when the nonvolatile memory is used, the number of rewritable times of data is taken into consideration. Hence, in order to avoid the number of rewrite times from reaching the limit of the number of rewritable times, the SSD 116 executes wear leveling processing which prevents data from being written in an area indicated by identical addresses on the physical address space. For example, when transition processing from the working state to the hibernate state is executed a plurality of times, that is, when the hibernate data is written in the nonvolatile memory a plurality of times, the hibernate data is written in three different address areas on the physical address space 1, as shown in FIG. 2.

More specifically, for example, a case will be assumed wherein the transition processing to the hibernate state is executed three times. In the first transition processing to the hibernate state, hibernate data, which is assigned to 10th to 20th addresses on the logical address space, is written in an area indicated by 30th to 40th addresses on the physical address space 1 (as indicated by Hibernate data (old) in FIG. 2). In the second transition to the hibernate state, hibernate data, which is assigned to the 10th to 20th addresses on the logical address space, is written in an area indicated by 50th to 60th addresses on the physical address space 1 (as indicated by Hibernate data (old) in FIG. 2). In the third transition to the hibernate state, hibernate data, which is assigned to the 10th to 20th addresses on the logical address space in the third transition to the hibernate state, is written in an area indicated by 70th to 80th addresses on the physical address space 1 (as indicated by Hibernate data (new) in FIG. 2). As described above, the hibernate data, which is assigned to the area indicated by the same addresses on the logical address space, is written in the different address areas on the physical address space 1. Note that conversion from logical addresses to physical addresses is performed by the SSD 116 upon writing the hibernate data to the SSD 116.

A case will be described below wherein hibernate data is stored in the SLC area 20. In this embodiment, the hibernate data is written in the SLC area 20. The hibernate data written in the SLC area 20 is processed not to undergo the wear leveling processing.

More specifically, hibernate data, which is assigned to the 10th to 20th addresses on the logical address space, is written in an area indicated by 0th to 10th addresses of the SLC area 20 on the physical address space 2. After that, the state of the computer is transited from the hibernate state to the working state, and then from the working state to the hibernate state again. In this case, the hibernate data, which is assigned to the 10th to 20th addresses on the logical address space, is written again in the area indicated by the 0th to 10th addresses of the SLC area 20 on the physical address space 2 as that in which the hibernate data was written once.

The hibernate data is data which is temporarily used by the computer 10 when the computer 10 transits to the hibernate state or from the hibernate state to the working state. In other words, the hibernate data is data which is not used again after the computer transits from the hibernate state to, for example, the working state. For this reason, as described above, to store the hibernate data in the plurality of different storage areas (for example, those indicated by Hibernate (old) and Hibernate (new) in FIG. 2) indicated by different addresses on the physical address space 1 by the wear leveling processing results in unnecessarily dispersion of the data. Also, as described above, the speeds of read and write accesses to the SLC area 20 are higher than those to the MLC area 21. Hence, by writing the hibernate data in the SLC area 21, a time period required for the computer 10 to transit to the hibernate state and to transit from the hibernate state to, for example, the working state, can be shortened by writing the hibernate data in the SLC area 21.

Furthermore, the hibernate data is data, which is temporarily used, as described above. For this reason, after the computer transits from the hibernate state to another state, the storage area in the SLC area 20 in which the hibernate data was written can be released. By releasing the SLC area 20 in which the hibernate data was stored, another data can be written in the SLC area 20 having higher performance than the MLC area 21, as described above, thus effectively using the SLC area 20 by exploiting its features.

The SSD 116 is configured to secure a storage area in the SLC area upon writing the hibernate data in the SLC area. The secured storage area is used to write hibernate data in the SLC area. For this purpose, in this embodiment, when, for example, other data different from the hibernate data is written in a storage area in which the hibernate data is to be written, processing for moving the other data to another storage area is executed.

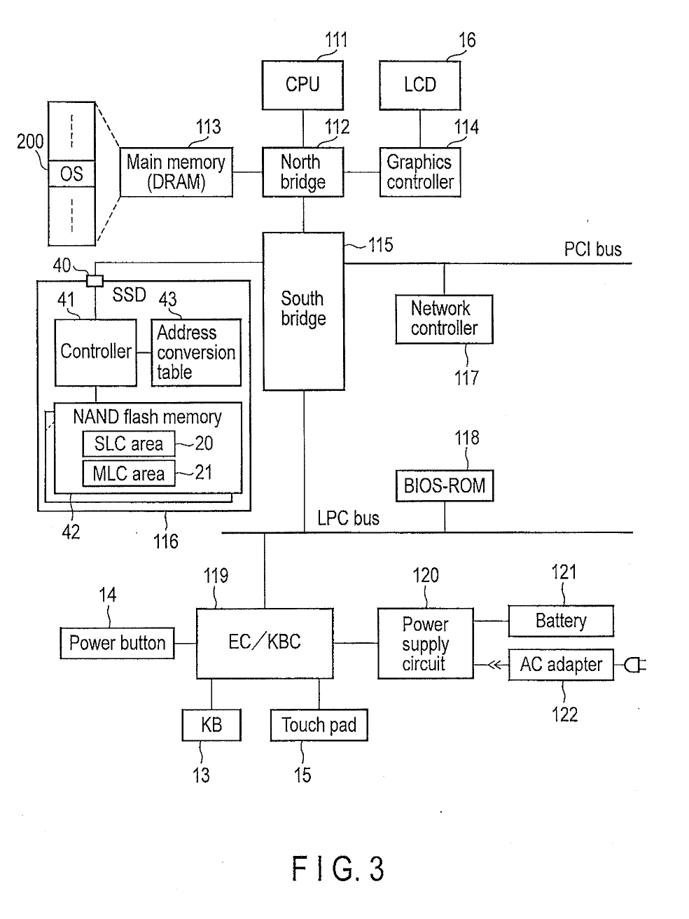

A system arrangement example of the computer 10 will be described below with reference to FIG. 3.

The computer 10 includes a CPU 111, north bridge 112, main memory (DRAM) 113, graphics controller 114, south bridge 115, SSD 116, network controller 117, BIOS-ROM 118, embedded controller/keyboard controller IC (EC/KBC) 119, power supply circuit 120, and the like.

The CPU 111 is a processor, which controls the operations of respective components of the computer 10. Also, the CPU 111 executes an OS (Operating System) 200 and various application programs, which are loaded from the SSD 116 onto the main memory 113.

The north bridge 112 is a bridge device which connects between a local bus of the CPU 111 and the south bridge 115. The north bridge 112 also has a function of executing communications with the graphics controller 114. Furthermore, the north bridge 112 incorporates a memory controller required to control the DRAM 113.

The graphics controller 114 is a display controller which controls the LCD 16 used as a display monitor of the computer 10. The south bridge 115 is connected to a PCI (Peripheral Component Interconnect) bus and LPC (Low Pin Count) bus, respectively.

The embedded controller/keyboard controller IC (EC/KBC) 119 is a 1-chip microcomputer which integrates an embedded controller for power management, and a keyboard controller required to control the keyboard (KB) 13, pointing device 15, and the like. The EC/KBC 119 powers on and powers off the computer 10 in response to an operation of the power button switch 14 by the user in cooperation with the power supply circuit 120. The power supply circuit 120 generates system power to be supplied to the respective components of the computer 10 using a battery 121 built in the computer main body 11 or an external power supplied via an AC adapter 122.

The SSD 116 includes an interface 40, controller 41, NAND flash memory 42, and address conversion table 43.

The interface 40 is that required to connect the south bridge 115 and controller 41. The NAND flash memory 42 is connected to the controller 41. The NAND flash memory 42 is a nonvolatile memory configured by the aforementioned SLC area 20 and MLC area 21. The address conversion table 43 is connected to the controller 41. The address conversion table 43 stores logical address values on the logical address space, and physical address values on the physical address space.

The controller 41 is connected to the address conversion table 43 and NAND flash memory 42. The controller 41 controls, for example, an operation for reading data from the NAND flash memory 42, an operation for writing data in the NAND flash memory 42, and the aforementioned wear leveling processing, and the like.

The controller 41 receives a write request required to write data in the SSD 116, and executes a write operation of writing the write data in the NAND flash memory 42 in accordance with that write request. The write request includes logical addresses of the write data. The controller 41 writes the write data indicated by the logical addresses in a specific storage area of the NAND flash memory 42. The controller 41 saves physical address values indicating the specific storage area in which the write data is written in the address conversion table 43. The physical address values saved in the address conversion table 43 are associated with the logical address values of the write data which is written in the specific storage area indicated by the physical address values.

The controller 41 receives a data read request from the OS 200, and reads data written in the specific storage area of the NAND flash memory 42. The read request includes, for example, logical addresses of data to be read out. The controller 41 specifies physical addresses corresponding to the logical addresses indicated by the read request with reference to the address conversion table 43. The controller 41 reads the data from the storage area in the NAND flash memory 42, which area is indicated by the specified physical addresses. The controller 41 loads the read data onto the DRAM 113 or the like.

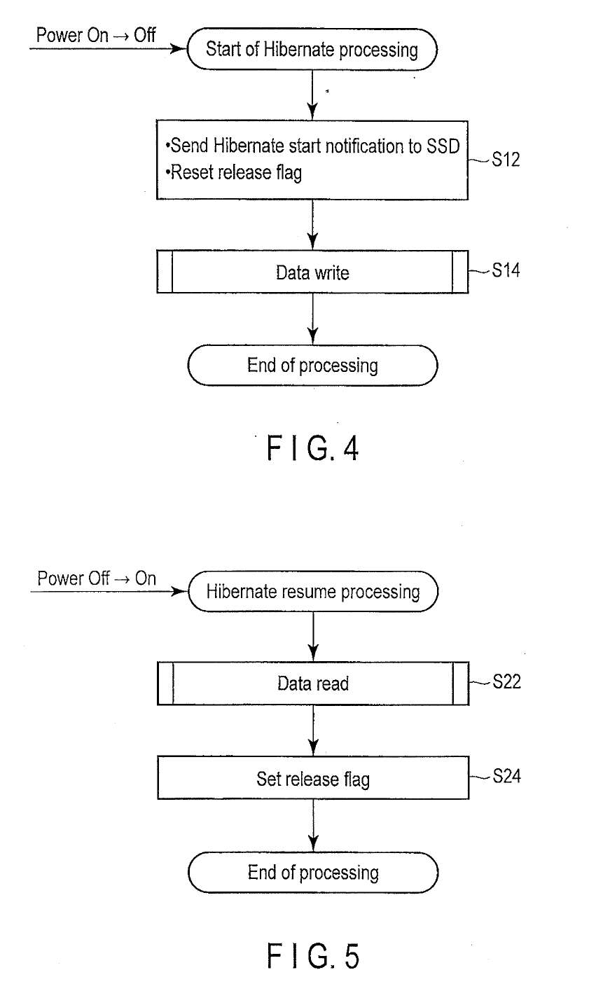

The transition processing from the working state to the hibernate state will be described below with reference to FIG. 4.

Initially, the user who uses the computer 10 makes an operation to turn off the computer 10, which is in a power-ON state, that is, in the working state. This operation means an event generated when the user presses, for example, the power button 14. According to this event, the OS 200 sends a request (hibernate request) required to control the computer 10 to transit from the working state to the hibernate state to a BIOS stored in the BIOS-ROM 118. Hibernate data is system context data including the contents of the main memory 113. The hibernate data includes not only the contents of the main memory 113 but also those of other volatile memories (for example, a video memory and the like) other than the main memory 113, and information such as respective register values of the CPU 111. The hibernate data is prepared on the main memory 113 by the OS 200. The BIOS executes processing for saving the hibernate data including the contents of the volatile memories (main memory 113 and the like) in the specific storage area (first storage area) in the SLC area 20 in response to this hibernate request.

More specifically, the BIOS sends a start notification of a write access of the hibernate data to the SLC area 20 (to be also referred to as a hibernate start notification hereinafter) to the SSD 116 (step S12). As described above, in this embodiment, the hibernate data written in the first storage area in the SLC area 20 is handled as temporary data. After the hibernate data is read from the first storage area, the first storage area is released to allow to write other data in the first storage area. This release processing is performed by, for example, setting a release flag, which instructs to release the first storage area where the hibernate data was stored, in a register of the controller 41.

In order to transit the computer 10 to the hibernate state, the BIOS resets the release flag in the SSD 116, so as to reset the already set release flag (step S12). Thus, even if it is required to detach the SSD 116 from the computer 10 in the hibernate state and to write arbitrary data in the SSD 116 detached, the first storage area in which the hibernate data is written is prevented from being overwritten by other data.

The controller 41 recognizes that write data with a write request, which is received after reception of the hibernate start notification, is hibernate data. The BIOS sends a write request required to write the hibernate data in the SSD 116 to the controller 41 of the SSD 116 (step S14). A logical address range included in this write request as write addresses is logical addresses 10 to 20.

Upon completion of the write access of the hibernate data to the SSD 116, that is, upon completion of saving of the hibernate data, the BIOS controls to power off the computer 10 in cooperation with the power supply circuit 120. When the computer 10 is powered off, the processing for controlling the computer 10 to transit to the hibernate state ends.

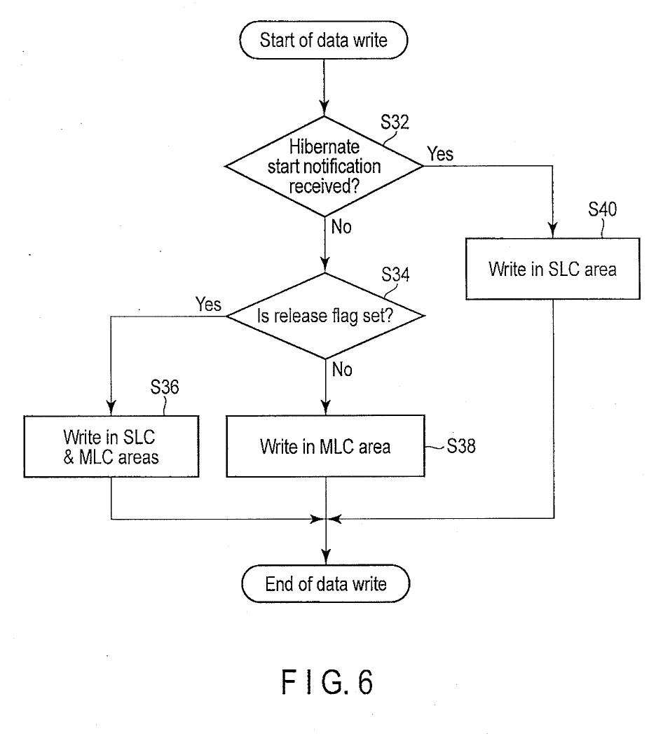

The transition processing from the hibernate state to the working state will be described below with reference to FIG. 5.

Initially, the user who uses the computer 10 makes an operation to turn on the computer 10. This operation is, for example, pressing of the power button 14. In response to this operation, the computer 10 is powered on. When the computer 10 is powered on, the CPU 111 executes the BIOS first. The BIOS recognizes the power-ON event of the computer 10 in the hibernate state as a request (resume request) required to control the computer 10 to transit from the hibernate state to the working state. In response to this resume request, the BIOS reads the hibernate data from the first storage area, and restores the contents of the main memory 113 (step S22). In step S22, the BIOS sends a read request including the logical addresses 10 to 20 as read addresses to the controller 41 of the SSD 116. In the address conversion table 43, the logical addresses 10 to 20 are registered as the logical address range corresponding to a physical address range of the first storage area where the hibernate data is stored. Therefore, the controller 41 reads the data (hibernate data) from the first storage area according to the aforementioned read request.

The read hibernate data is reloaded onto the main memory 113 and the like. Upon completion of the read of the hibernate data, the BIOS releases the first storage area, so that the first storage area where the read hibernate data was stored can be used to store other data (step S24). In step S24, the BIOS instructs the controller 41 to release the first storage area, by setting the release flag required to release the first storage area where the hibernate data was stored in the controller 41. The controller 41 invalidates the hibernate data stored in the first storage area, thereby releasing the first storage area. In this case, the controller 41 may erase the data stored in the first storage area.

In place of the explicit release instruction of the first storage area which is issued by the BIOS to the controller 41, the controller 41 may automatically release the first storage area where the hibernate data was stored, upon completion of the read of the hibernate data.

The data write control of the controller 41 of the SSD 116 will be described below with reference to FIG. 6. Note that processing shown in FIG. 6 also includes write processing of data other than the hibernate data.

Upon reception of a write request from the OS 200 or BIOS, the SSD 116 determines whether or not the hibernate start notification has already been received (step S32). If the hibernate start notification has already been received (YES in step S32), the SSD 116 recognizes write data with the write request as hibernate data. Then, the SSD 116 writes this write data in the first storage area secured in the SLC area 20 (step S40). Processing for securing the storage area used to store the hibernate data in the SLC area 20 is executed by, for example, the SSD 116 when the SSD 116 receives the hibernate start notification.

If any hibernate start notification is not received (NO in step S32), the SSD 116 determines whether or not the release flag is set (step S34). If the SSD 116 determines that the release flag is set (YES in step S34), the SSD 116 recognizes all storage areas including the SLC area 20 and MLC area 21 as writable areas, and the SSD 116 writes the write data in a predetermined storage area selected from the writable areas (step S36). If the SSD 116 determines that the release flag is not set (NO in step S34), the SSD 116 recognizes only the MLC area 21 as a writable area, and the SSD 116 writes the write data in a predetermined storage area selected from the MLC area 21 (step S38).

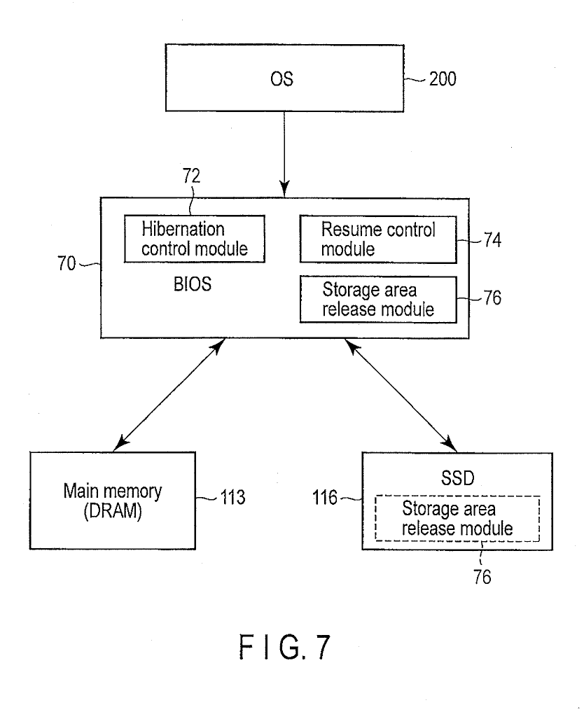

Finally, the configuration of a BIOS 70 will be described below with reference to FIG. 7. The BIOS 70 includes a hibernation control module 72, resume control module 74, and storage area release module 76. Note that the function of the storage area release module 76 may be implemented by the controller 41 in the SSD 116.

The hibernation control module 72 controls the computer 10 to transit from the working state to the hibernate state. More specifically, in response to a hibernate request from the OS 200 or the like, the hibernation control module 72 saves hibernate data including the contents of the volatile memories such as the main memory 113 in the specific storage area in the SLC area 20. The resume control module 74 controls the computer 10 to transit from the hibernate state to the working state. More specifically, in response to, for example, a power-ON event (resume request) of the computer 10 after the computer 10 transited to the hibernate state, the resume control module 74 reads the hibernate data from the storage area, where the hibernate data is stored, in the SLC area 20. Then, the resume control module 74 restores the contents of the volatile memories such as the main memory 113. Thus, the states of various devices including the CPU 111, main memory 113, and the like in the computer 10 are restored to the states immediately before transition to the hibernate state. Then, the computer 10 resumes processing from the state immediately before transition to the hibernate state.

In response to completion of the read of the hibernate data from the SSD 116, the storage area release module 76 instructs the SSD 116 to release the first storage area where the hibernate data is stored. More specifically, in response to completion of the read of the hibernate data, the storage area release module 76 releases the storage area where the hibernate data was stored, so as to allow that storage area to store another data. Note that the storage area release module 76 may send a command for invalidating the hibernate data to the SSD 116. The storage area release module 74 may instruct the SSD 116 to release the first storage area using this command. As the command for invalidating the hibernate data, a trim command may be used.

As described above, according to this embodiment, when the computer 10 is controlled to transit to the hibernate state, hibernate data is stored in the SLC area 20. For this reason, the state of the computer 10 can be transited between the working state and the hibernate state at higher speed. After the hibernate data is read, the storage area in the SLC area 20 where the read hibernate data was stored is released. Thus, the released SLC area 20 can be used for other data, thus efficiently using the characteristics of the SLC area 20 in terms of reliability, performance, cost, and so forth.

In this embodiment, one or more storage areas of storage areas (MLC areas) in a NAND flash memory of an MLC type in an SLC mode may be controlled in an SLC mode. In this case, the one or more storage areas can also be used as the aforementioned SLC area. Respective cells in the storage areas controlled in the SLC mode are physically MLCs, but each of these cells is controlled to be written with 1 bit.

All the procedures described in the flowcharts shown in FIGS. 4 and 5 can be implemented by programs. Hence, by only installing and executing these programs in the computer via a computer-readable storage medium storing the programs, the same effects as in this embodiment can be easily implemented.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a volatile memory;
a nonvolatile semiconductor disk drive comprising a single-level cell (SLC) area and a multi-level cell (MLC) area;
a hibernation controller configured to save system context data in a first storage area in the SLC area in response to a hibernate request, the system context data comprising contents of the nonvolatile memory;
a resume controller configured to read the system context data from the first storage area to restore the contents of the volatile memory in response to a resume request; and
a release module configured to release the first storage area to allow the first storage area to be used to store other data, wherein the release module is configured to release the first storage area in response to completion of the read of the system context data.

2. The apparatus of claim 1,
wherein the release module is further configured to instruct the nonvolatile semiconductor disk drive to release the first storage area, in response to completion of the read of the system context data.

3. The apparatus of claim 1,
wherein the hibernation controller is further configured to send a write start notification of the system context data to the nonvolatile semiconductor disk drive, and further configured to send a write request to the nonvolatile semiconductor disk drive to write the system context data in the nonvolatile semiconductor disk drive, and
wherein the nonvolatile semiconductor disk drive is further configured to determine, in response to receipt of the write request, whether the write start notification of the system context data is received, and configured to write, if the write start notification is received, write data with the received write request in the first storage area.

4. The apparatus of claim 3,
wherein the nonvolatile semiconductor disk drive is further configured to secure the first storage area in the SLC area if the nonvolatile semiconductor disk drive receives the write start notification of the system context data.

5. A control method for an information processing apparatus comprising a nonvolatile semiconductor disk drive, the drive comprising a single-level cell (SLC) area and a multi-level cell (MLC) area; the method comprising:
saving system context data in a first storage area in the SLC area in response to a hibernate request, the system context data comprising contents of a nonvolatile memory in the information processing apparatus;
reading the system context data from the first storage area to restore the contents of the volatile memory, in response to a resume request; and
releasing the first storage area to allow the first storage area to be used to store other data, in response to completion of the read of the system context data.

6. The method of claim 5,
wherein releasing the first storage area comprises instructing the nonvolatile semiconductor disk drive to release the first storage area in response to completion of the read of the system context data.

7. A computer-readable, non-transitory storage medium having stored thereon a computer program which is executable by a computer which comprises a nonvolatile semiconductor disk drive comprising a single-level cell (SLC) area and a multi-level cell (MLC) area, the computer program configured to control the computer to execute functions of:
saving system context data in a first storage area in the SLC area in response to a hibernate request, the system context data comprising contents of a nonvolatile memory of the computer;
reading the system context data from the first storage area to restore the contents of the volatile memory in response to a resume request; and
releasing the first storage area to allow the first storage area to be used to store other data, in response to completion of the read of the system context data.
